(19) United States
(12) Patent Application Publication
(10) Pub. No.: US 2026/0247307 A1
(43) Pub. Date: Aug. 20, 2026

(54) SIDELINK TRANSMISSION FOR ACCURATE AUTOMATIC GAIN CONTROL

(71) Applicant: QUALCOMM Incorporated, San Diego, CA (US)

(72) Inventors: Daniel HOROVITZ, Kiryat Tivon (IL); Moshe BEN-ARI, Rehovot (IL); Alexander SVERDLOV, Rehovot (IL); Michael LEVITSKY, Rehovot (IL)

(21) Appl. No.: 19/055,933

(22) Filed: Feb. 18, 2025

(51) Int. Cl. H04W 52/52; H04W 72/0446; H04W 72/40

(52) U.S. Cl. CPC H04W 52/52; H04W 72/0446; H04W 72/40

(57) ABSTRACT

Certain aspects of the present disclosure provide techniques for wireless communications by a device. A method generally includes receiving, on a sidelink from a second UE, a first automatic gain control (AGC) symbol associated with a physical sidelink control channel (PSCCH) transmission and a second AGC symbol associated with a physical sidelink shared channel (PSSCH) transmission, wherein the first AGC symbol and the second AGC symbol are within a symbol length of the sidelink, and obtaining at least one of the PSCCH transmission or the PSSCH transmission on the sidelink in accordance with a gain parameter associated with a corresponding symbol, of the first AGC symbol or the second AGC symbol.

### INTRODUCTION

### Field of the Disclosure

Aspects of the present disclosure relate to wireless communications, and more particularly, to techniques for communicating sidelink transmissions for improved automatic gain control.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications performed by a first user equipment (UE). The method includes receiving, on a sidelink from a second UE, a first automatic gain control (AGC) symbol associated with a physical sidelink control channel (PSCCH) transmission and a second AGC symbol associated with a physical sidelink shared channel (PSSCH) transmission, wherein the first AGC symbol and the second AGC symbol are within a symbol length of the sidelink; and obtaining at least one of the PSCCH transmission or the PSSCH transmission on the sidelink in accordance with a gain parameter associated with a corresponding symbol, of the first AGC symbol or the second AGC symbol.

Certain aspects provide a method of wireless communications performed by a second UE. The method includes sending, on a sidelink to a first UE, a first AGC symbol associated with a PSCCH transmission and a second AGC symbol associated with a PSSCH transmission, wherein the first AGC symbol and the second AGC symbol are within a symbol length of the sidelink; and sending at least one of the PSCCH transmission or the PSSCH transmission on the sidelink.

Certain aspects provide a method of wireless communications by a UE. The method includes sending, using a multi-antenna configuration of a corresponding PSSCH symbol, a PSCCH symbol associated with the PSSCH symbol; and sending the PSSCH symbol using the multi-antenna configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a diagram illustrating an example of sidelink communications.

FIG. 6 depicts a diagram illustrating an example of sidelink communications and access link communications.

FIG. 7 depicts a diagram illustrating an example of sidelink communications using a multi-antenna configuration.

FIG. 8 depicts a process flow for sidelink communications between a first UE and a second UE for transmitting symbols for automatic gain control.

FIG. 9 depicts a process flow for sidelink communications between a first UE and a second UE for transmitting symbols for automatic gain control.

FIG. 10 depicts example slots including symbols usable by a receiving UE for performing automatic gain control.

FIG. 11 depicts a method for wireless communications.

FIG. 12 depicts another method for wireless communications.

FIG. 13 depicts another method for wireless communications.

FIG. 14 depicts aspects of an example communications device.

### DETAILED DESCRIPTION

Aspects of the present disclosure provide apparatuses, methods, processing systems, and computer-readable mediums for communicating sidelink transmissions for improved automatic gain control.

A wireless communications system may support sidelink communication. Sidelink communication refers to communication between two user equipment (UEs). For example, sidelink communications may occur between the two UEs without passing via a radio access network or a network entity such as a gNB. Communications on the sidelink may be performed on a sidelink resource pool. A sidelink resource pool may include a number of slots. A slot may include a number of symbols. Sidelink communications may be performed on physical channels, including a physical sidelink shared channel (PSSCH) used for data and control transmission, or a physical sidelink control channel (PSCCH) used for control transmission. A transmission on a PSSCH may be referred to herein as a PSSCH transmission and may be referred to as including PSSCH symbols or PSSCH slots. A transmission on a PSCCH may be referred to herein as a PSCCH transmission and may be referred to as including PSCCH symbols or PSCCH slots.

UEs performing sidelink communication may perform automatic gain control (AGC). AGC allows a UE to change the gain of a received signal such that the signal falls within a range of an analog to digital converter (ADC). This AGC may be performed based on a part of a sidelink communication. For example, a first symbol of a slot may be a duplicate of a later symbol included in a PSSCH or a PSCCH slot following the first symbol. This first symbol can be used for AGC, since the receiving UE can measure a signal strength on the first symbol and adjust receiver configuration before receiving the later symbol of the PSSCH or PSCCH slot. As used herein, an “AGC symbol” may refer to any symbol of a slot used by a receiving UE to measure a signal strength, such as to adjust gain for a received signal of a PSSCH or PSCCH symbol (e.g., in the slot).

UEs communicating over a sidelink may send and receive PSCCH transmissions and PSSCH transmissions using different antenna configurations. As used herein, an “antenna configuration” refers to an arrangement, number, and/or functional setup of antennas for transmitting and receiving signals during wireless communication. For example, in some deployments, PSCCH transmissions may be transmitted over the sidelink using a single-antenna configuration, while PSSCH transmissions may be transmitted over the sidelink using a multi-antenna configuration, such as a dual-antenna configuration (e.g., for cyclic delay diversity or multiple-input multiple-output).

At certain times, a first symbol being used for AGC may fail to sufficiently account for received power differences between the first symbol and one or more following PSCCH or PSSCH transmissions that are transmitted using different antenna configurations. For example, if a first symbol being used by a receiving UE for AGC is a duplicate of a PSCCH symbol, then the receiving UE may inaccurately adjust gain of a received signal associated with a transmission corresponding to PSSCH symbols following the first symbol due to a lack of accurate information reflective of received power associated with the PSSCH transmission. More specifically, if the PSCCH is transmitted on only one antenna, the UE may not obtain useful information about received power of the PSSCH transmission which is transmitted on multiple antennas due to an antenna imbalance, described below. Failure of a receiving UE communicating over a sidelink to accurately adjust gain of a received signal based on an AGC symbol that accurately reflects received power of a given transmission can lead to increased saturation and signal clipping due to overestimating received power, or increased quantization errors and reduced decoding accuracy due to underestimating received power.

Continuing the above example, accurate AGC for enabling a UE communicating over a sidelink to accurately predict received power for adjusting its gain is complicated by antenna imbalances. As used herein, “antenna imbalance” may refer to an unequal distribution of signal strength or performance between two or more different antennas utilized by a shared sidelink. For example, a transmitting UE communicating over a sidelink may utilize a car installation supporting a cellular vehicle-to-everything (CV2X) framework including a first transmitting antenna and a second transmitting antenna. Receiving antennas of a receiving UE may experience different signal strength or performance with regard to transmissions of the first transmitting antenna and transmissions of the second transmitting antenna, creating antenna imbalance between the receiving antennas of the receiving UE and the transmitting antennas of the transmitting UE. For example, antenna imbalance may be created based on antenna positioning, obstructions, frequency variations, or changing conditions due to mobility. Accordingly, an existing antenna imbalance can exacerbate existing challenges experienced by UEs communicating over a sidelink when trying to accurately set AGC parameters (e.g., gain) for reception of a given transmission based on received power. For example, antenna imbalance may increase the negative impact of relying on a singular duplicate PSCCH symbol that provides no context for transmissions associated with a PSSCH symbol for a PSSCH transmission sent using a different antenna configuration.

Accordingly, a technical problem arises with respect to how a first UE and a second UE communicating over a sidelink can provide an AGC symbol that accurately reflects received power for both PSCCH and PSSCH transmissions, thereby enabling a receiving UE to adjust gain of a received signal such that the signal falls within a range of an ADC. Certain aspects herein provide a technical solution to this technical problem, such as by providing techniques for transmitting a first AGC symbol associated with a PSCCH transmission and a second AGC symbol associated with a PSSCH transmission within a symbol length of a sidelink. This may allow the UE to obtain at least one of the PSCCH transmission or the PSSCH transmission on the sidelink in accordance with a gain parameter associated with a corresponding symbol such as one of the first AGC symbol or the second AGC symbol. This may provide the technical benefit of allowing the receiving UE to utilize an AGC symbol that more closely reflects the power received in both the control and data portions of the slot, thereby reducing saturation and/or quantization errors caused by the receiving UE adjusting gain of a signal based on an AGC symbol that inaccurately reflects received power for a transmission. Compressing the first AGC symbol associated with a PSCCH transmission and the second AGC symbol associated with a PSSCH transmission within the symbol length of a slot further provides the technical benefit of reducing overhead costs (such as bandwidth) from the perspective of a transmitting UE as compared to providing two separate AGC symbols in two respective slot lengths.

Another technical problem arises with respect to how UEs communicating over a sidelink can ensure transmission of PSCCH and PSSCH symbols that accurately reflect received power of PSCCH transmissions, when PSCCH symbols are typically sent using a different antenna configuration than the PSSCH symbols. Certain aspects herein provide another technical solution, such as by providing techniques for sending PSCCH symbols based on (e.g., using) a multi-antenna configuration of a corresponding PSSCH symbol, such as a PSSCH symbol in the same slot as the PSCCH symbol. For example, a first UE communicating over a sidelink may send PSCCH symbols using a dual-antenna configuration associated with corresponding PSSCH symbols. This may allow the received power for PSCCH transmissions to match the PSSCH transmission from the perspective of a receiving antenna at the second UE, thereby providing the technical benefit of allowing the receiving UE to adjust gain for received signals based on PSCCH symbols that more closely reflects the power received in both the control and data portions of the slot, thereby reducing saturation and/or quantization errors.

In some examples, UEs communicating over a sidelink may send and receive PSSCH transmissions using a multi-antenna configuration employing a cyclic delay-diversity (CDD) framework. As used herein, “CDD” refers to a framework for enhancing signal diversity by applying cyclic time delays to transmitted signals across multiple antennas. CDD may reduce fading and improve spatial diversity without requiring additional bandwidth by using a first antenna to transmit an original copy of data, and one or more other antennas to transmit cyclic shifted versions of the original data. In some aspects, UEs communicating over a sidelink using a CDD framework may send a PSCCH symbol using a multi-antenna configuration (e.g. including a given number of antenna ports) and signal delays based on a multi-antenna configuration and signal delays used for sending a corresponding PSSCH symbol. Sending the PSCCH symbol using the multi-antenna configuration and signal delays used for sending a corresponding PSSCH symbol ensures the received power for PSCCH transmissions matches the PSSCH transmission from the perspective of a receiving antenna at the second UE. This allows the receiving UE to adjust gain for received signals based on PSCCH symbols that more closely reflects the power received in both the control and data portions of the slot, thereby providing the technical benefit of reducing saturation and/or quantization errors.

In other examples, UEs communicating over a sidelink may send and receive PSSCH transmissions using a multiple-antenna configuration for employing a multiple-input and multiple-output (MIMO) framework. As used herein, “MIMO” refers to a wireless communication framework in which multiple data streams are sent and received simultaneously over the same frequency band using techniques such as spatial multiplexing and beamforming to increase data rates and signal reliability. In some aspects, UEs communicating over a sidelink using a MIMO framework may send a PSCCH symbol using a multi-antenna configuration based on a multi-antenna configuration of a corresponding PSSCH symbol. In certain aspects, a transmitting UE using a MIMO framework may alternate between using one or more antenna ports corresponding to a multi-antenna configuration of a corresponding PSSCH symbol for sending respective contiguous resource block groups associated with a given PSCCH symbol. Sending the PSCCH symbol using a multi-antenna configuration based on a multi-antenna configuration of a corresponding PSSCH symbol ensures the received power for PSCCH transmissions matches the PSSCH transmission from the perspective of a receiving antenna at the second UE. This allows the receiving UE to adjust gain for received signals based on PSCCH symbols that more closely reflects the power received in both the control and data portions of the slot, thereby providing the technical benefit of reducing saturation and/or quantization errors.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

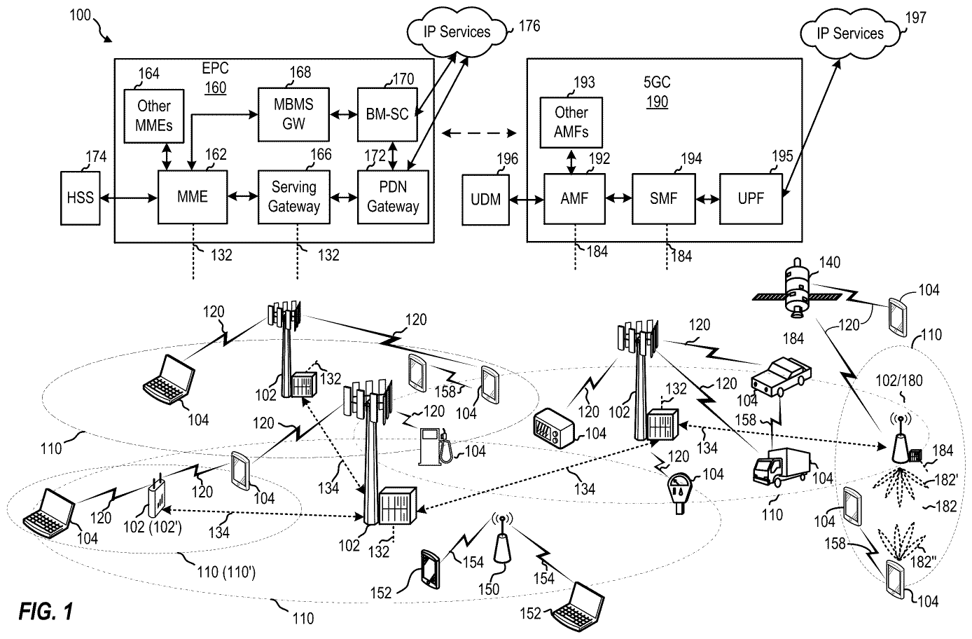

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

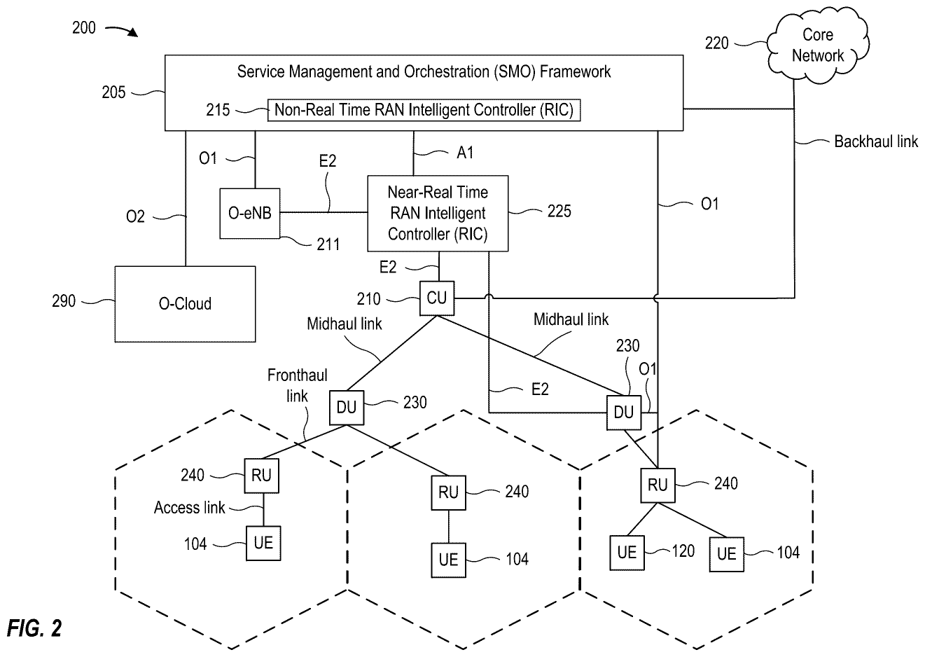

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR 1) as including 410 MHz-7125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

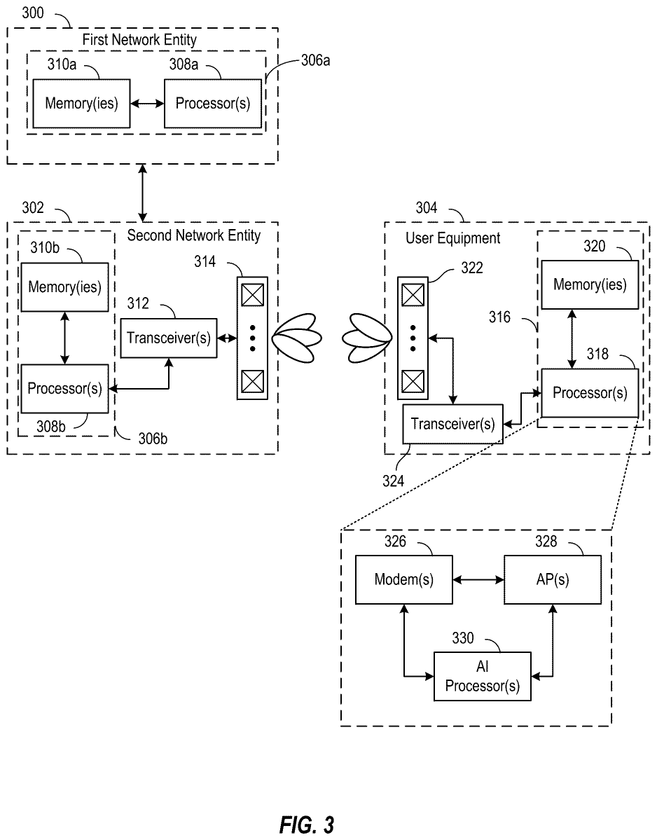

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

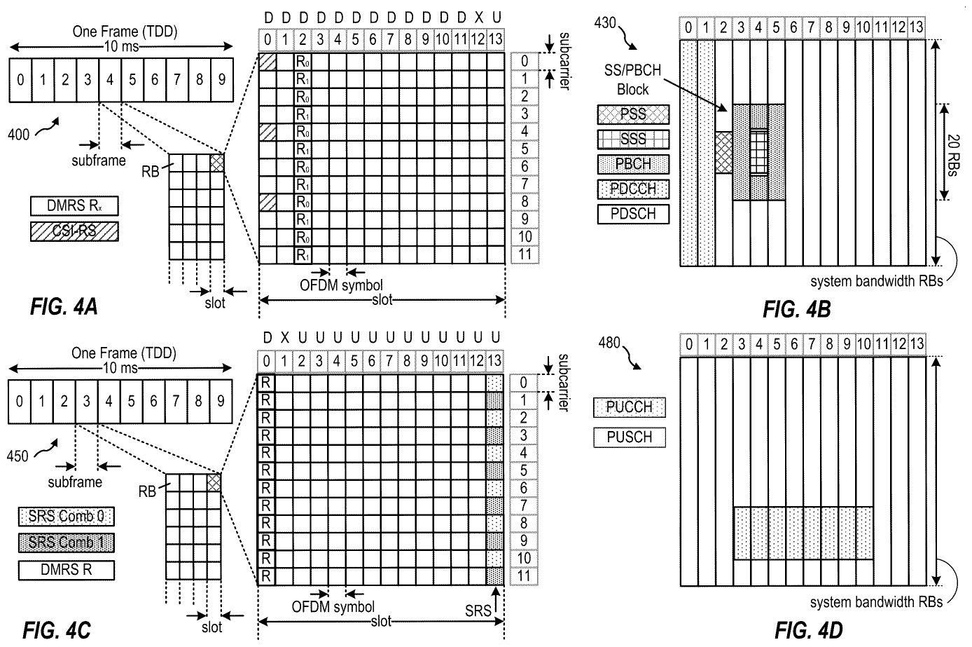

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Communicating Sidelink Transmissions for Improved Automatic Gain Control

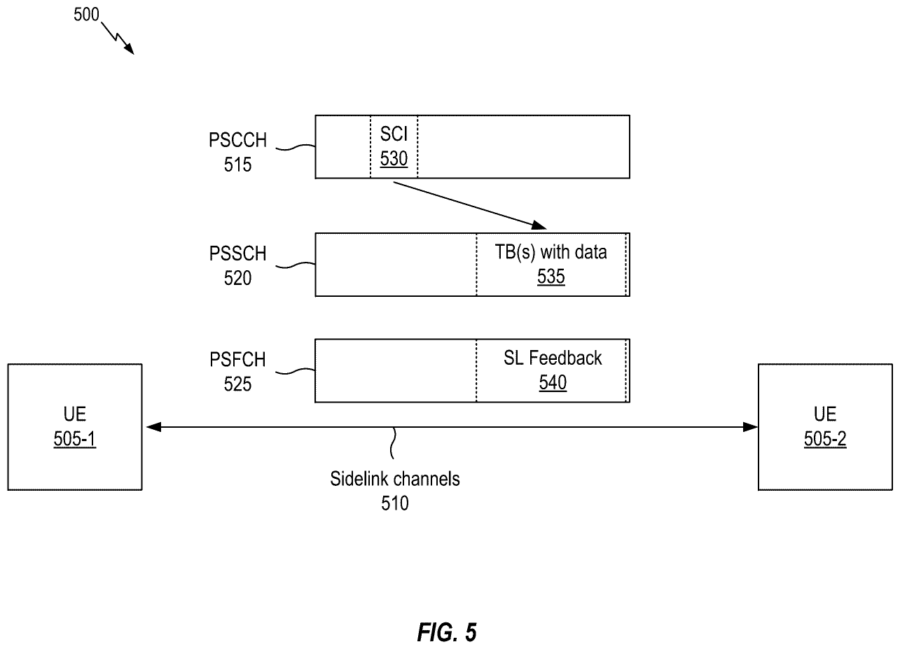

FIG. 5 is a diagram illustrating an example 500 of sidelink communications, in accordance with the present disclosure. As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for P2P communications, D2D communications, V2X communications (e.g., which may include V2V communications, V2I communications, and/or V2P communications) and/or mesh networking. In some aspects, the UEs 505 (e.g., UE 505-1 and/or UE 505-2) may correspond to one or more other UEs described elsewhere herein, such as UE 104 or 304. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with an NE 300 or 302 via an access link or an access channel. The PSSCH 520 may be used to communicate data, similar to a physical downlink shared channel (PDSCH) and/or a physical uplink shared channel (PUSCH) used for cellular communications with an NE 300 or 302 via an access link or an access channel. For example, the PSCCH 515 may carry SCI 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. For example, a scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a transmission mode where resource selection and/or scheduling is performed by the UE 505 (e.g., rather than an NE 300 or 302). In some aspects, the UE 505 may perform resource selection and/or scheduling by sensing channel availability for transmissions. For example, the UE 505 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy rate (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

As indicated above, FIG. 5 is provided as an example. Other examples may differ from what is described with respect to FIG. 5.

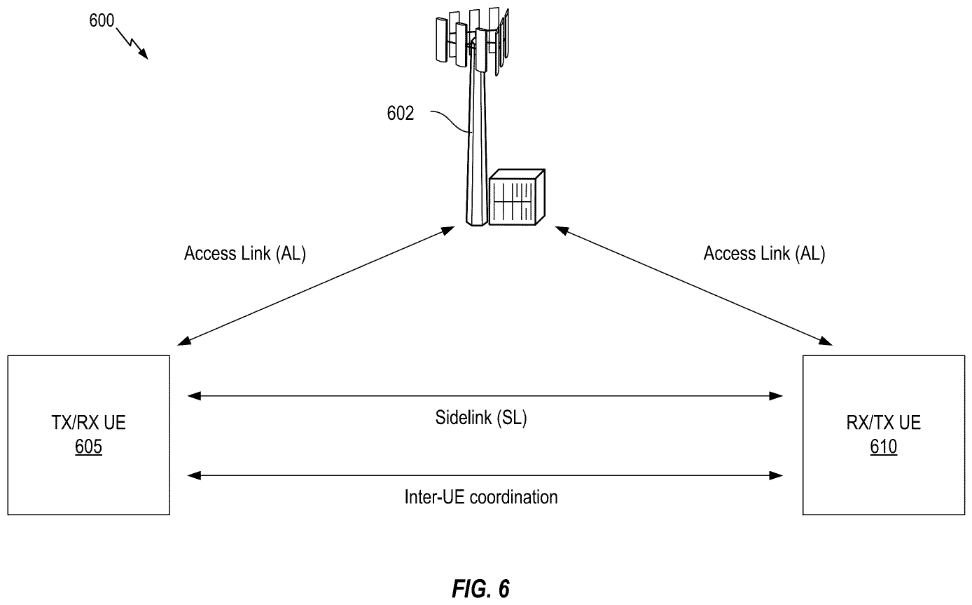

FIG. 6 is a diagram illustrating an example 600 of sidelink communications and access link communications, in accordance with the present disclosure. As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a NE 602 may communicate with the Tx/Rx UE 605 via a first access link. Additionally, or alternatively, in some sidelink modes, the NE 602 may communicate with the Rx/Tx UE 610 via a second access link. The Tx/Rx UE 605 and/or the Rx/Tx UE 610 may correspond to one or more UEs described elsewhere herein, such as the UE 104/304. Thus, a direct link between UEs 104/304 (e.g., via a PC5 interface) may be referred to as a sidelink, and a direct link between a NE 300/302 and a UE 104/304 (e.g., via a Uu interface) may be referred to as an access link. Sidelink communications may be transmitted via the sidelink, and access link communications may be transmitted via the access link. An access link communication may be either a downlink communication (from a NE 300/302 to a UE 104/304) or an uplink communication (from a UE 104/304 to a NE 300/302).

As indicated above, FIG. 6 is provided as an example. Other examples may differ from what is described with respect to FIG. 6.

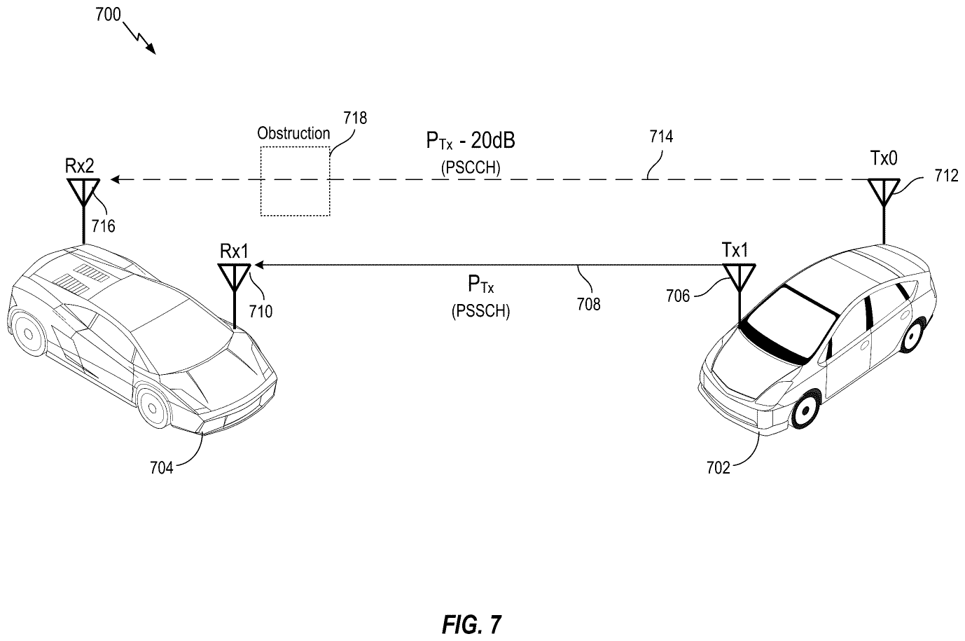

FIG. 7 is a diagram illustrating an example 700 of sidelink communications using a multi-antenna configuration in accordance with the present disclosure. As shown in FIG. 7, a vehicle 702 and a vehicle 704 are communicating using a sidelink channel for V2V communications. Vehicle 702 and 704 may correspond to or include one or more UEs described elsewhere herein, such as the UE 104/304. Vehicle 702 includes a first transmitting antenna 706 that is sending a PSSCH transmission 708. PSSCH transmission 708 is received at a receiving antenna 710 of vehicle 704. The received power for PSSCH transmission 708 is represented as “P_{Tx}”.

Vehicle 702 further includes a second transmitting antenna 712 that is sending a PSCCH transmission 714. PSCCH transmission 714 is received at a receiving antenna 716 of vehicle 704. The received power for PSCCH transmission 714 is represented as “P_{Tx}−20 dB”, indicating a decrease of 20 dB in the received power for PSCCH transmission 714 as compared to the received power for PSSCH transmission 708. In some cases, the PSSCH transmission 708 may also be transmitted on the second transmitting antenna 712, such that the PSSCH transmission 708 is sent using two antenna ports. As an example, transmitting the PSSCH transmission 708 using two antenna ports may further increases the disparity between the received power of the PSSCH transmission 708 and the PSCCH transmission 714 by an additional 3 dB (e.g., corresponding to 50% lower transmit power) between the transmitting antennas 706, 712. Accordingly, the different transmission schemes for sending the PSSCH transmission 714 and the PSCCH transmission 708 increases the difficulty in accurately determining received power of PSCCH transmissions for enabling the UE to accurately perform AGC. In some examples, the difference in received power for the PSSCH transmission 708 and the PSSCH transmission 714 may be attributed to receiving antenna 710 and 716 experiencing different signal strengths, creating antenna imbalance between the receiving antennas of vehicle 704 and the transmitting antennas of the vehicle 702. As shown, an obstruction 718 may cause the received power at receiving antenna 716 to decrease. In some example, antenna imbalance may be created based on one or more of antenna positioning, frequency variations, or changing conditions due to mobility. The antenna imbalance of 20 dB shown in FIG. 7 may cause, for example, an AGC error of about 17 dB for the received PSSCH symbols, leading to increased saturation.

As previously discussed, an antenna imbalance can exacerbate existing challenges experienced by UEs communicating over a sidelink when trying to perform AGC to accurately set gain parameters for an obtained transmission. As used herein, a “gain parameter” refers to any value usable by a UE to adjust the amplitude of a received signal of a PSCCH or PSSCH transmission, such that the received signal is within a range of an ADC. A gain parameter may be associated with a given AGC symbol, such that the gain parameter is determined by a UE based on the AGC symbol with which it is associated. In some examples, antenna imbalance can worsen the quality of a first symbol being used for AGC that already fails to sufficiently account for received power differences between a first symbol (used for AGC) and one or more following PSCCH or PSSCH transmissions that are transmitted using different antenna configurations. At certain times, if a first symbol being used by a receiving UE for AGC is a duplicate of a PSCCH symbol, then the receiving UE may inaccurately adjust gain of a received signal associated with a transmission corresponding to PSSCH symbols following the first symbol due to a lack of accurate information reflective of the received power associated with the PSSCH transmission. This challenge is amplified in the presence of an antenna imbalance caused by one or more of the reasons discussed above, as the antenna imbalance may increase the negative impact of relying on a singular duplicate symbol that provides no context for transmissions associated with a different symbol for a data type transmitted using a different antenna configuration. Failure of a receiving UE communicating over a sidelink to accurately adjust gain of a received signal based on an AGC symbol that accurately reflects received power of a transmission can lead to increased saturation and signal clipping due to overestimating received power, or increased quantization errors and reduced decoding accuracy due to underestimating received power.

Accordingly, in some aspects, it may be beneficial for the vehicle 702 to send PSCCH symbols based on (e.g., using) a multi-antenna configuration of a corresponding PSSCH symbol, such as a PSSCH symbol in the same slot as the PSCCH symbol to allow the received power for PSCCH transmissions to match the PSSCH transmission from the perspective of receiving antennas 710, 716 at vehicle 704. This provides the technical benefit of allowing the receiving antennas 710, 716 of vehicle 704 to adjust gain for received signals based on PSCCH symbols that more closely reflects the power received in both the control and data portions of an associated slot, thereby reducing saturation and/or quantization errors. Accordingly, certain aspects described herein include techniques for sending PSCCH symbols based on a multi-antenna configuration of a corresponding PSSCH symbol.

### Example Signaling of PSCCH/PSSCH Symbols for Improved AGC

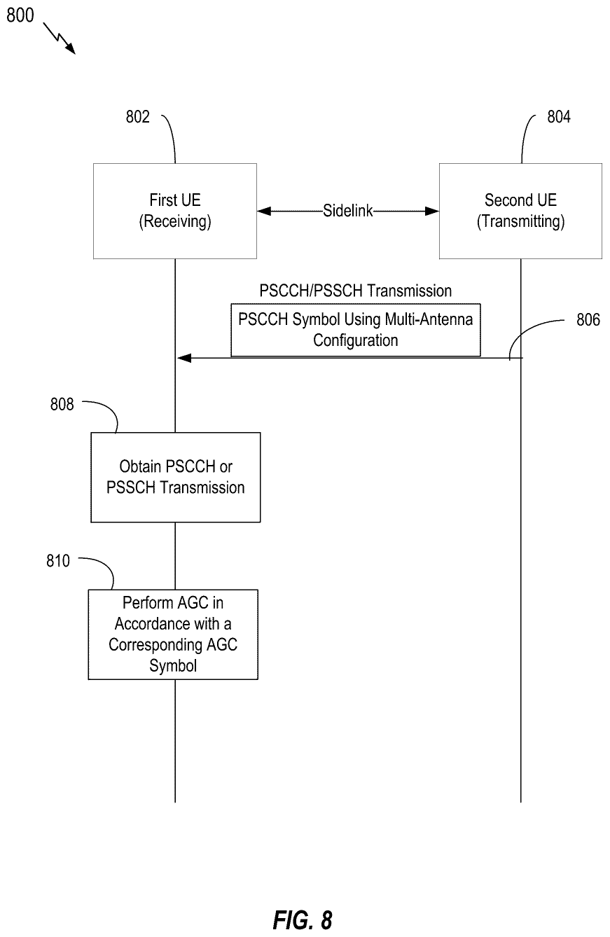

FIG. 8 depicts a process flow 800 for communications between a first UE 802 receiving a transmission, and a second UE 804 transmitting (e. g, sending) a transmission over a sidelink. In certain aspects, first UE 802 and second UE 804 may be referred to as “devices”. In process flow 800, second UE 804 sends a PSCCH/PSSCH transmission including a PSCCH symbol sent using a multi-antenna configuration of a corresponding PSSCH symbol. Process flow 800 enables a transmitting UE to send the PSCCH symbol using a multi-antenna configuration of a corresponding PSSCH symbol such that the received power for PSCCH transmissions matches the PSSCH transmission from the perspective of a receiving antenna of the receiving UE. This allows the receiving UE to perform AGC to adjust gain for received signals based on PSCCH symbols that more closely reflect the power received in both the control and data portions of the slot, thereby providing the technical benefit of reducing saturation and/or quantization errors.

In some aspects, UEs 802 and 804 may be an example of UE 104 depicted and described with respect to FIG. 1 or the UE 304 depicted and described with respect to FIG. 3. However, in other aspects, UEs 802 and 804 may be another type of wireless communications device, such as those described herein. Note that any operations or signaling illustrated with dashed lines may indicate that that operation or signaling is an optional or alternative example.

At 806, second UE 804 sends, to first UE 802, a PSCCH symbol of a PSCCH/PSSCH transmission using a multi-antenna configuration. The multi-antenna configuration used to send the PSCCH symbol corresponds to a multi-antenna configuration used to transmit a corresponding PSSCH symbol. As used herein, a “corresponding PSSCH symbol” refers to a PSSCH symbol in a same slot as the PSCCH symbol or used to transmit a shared transmission associated with a given PSCCH symbol. In some examples, if a corresponding PSSCH symbol is sent using a dual antenna configuration, such as using two separate transmitting antennas, then the PSCCH symbol is sent using a dual antenna configuration (a dual antenna configuration is an example of a multi-antenna configuration). Thus, the number of antenna ports used to transmit the PSCCH symbol will align with the number of antenna ports used to transmit the corresponding PSSCH symbol, thereby matching the transmission powers for the PSCCH and PSSCH transmissions.

In certain aspects, second UE 804 may send the PSCCH/PSSCH transmission to first UE 802 using a multi-antenna configuration associated with a CDD framework. For example, the multi configuration used by second UE 804 may employ a CDD framework that enhances signal diversity by applying cyclic time delays to transmitted signals across multiple antennas. As an example, second UE 804 may send first UE 802 a PSCCH symbol using a multi-antenna configuration (e.g. including a given number of antenna ports) and signal delays based on (e.g., that match) a multi-antenna configuration and signal delays used when sending a corresponding PSSCH symbol. In some examples, if second UE 804 sends a PSSCH symbol using both a first antenna port “Tx0” and a second antenna port “Tx1”, then UE 804 may similarly send a corresponding PSCCH symbol using both the first antenna port “Tx0” and the second antenna port “Tx1”. This enables the transmission power of the PSCCH transmission to match the PSSCH transmission.

In other aspects, second UE 804 may send the PSCCH/PSSCH transmission to first UE 802 using a multiple-antenna configuration associated with MIMO framework. For example, the multi-antenna configuration used by second UE 804 may employ a MIMO framework to send and receive multiple data streams simultaneously over the same frequency band (e.g., using techniques such as spatial multiplexing and beamforming to increase data rates and signal reliability). At certain times, second UE 804 may send a PSCCH symbol using a multi-antenna configuration based on (e.g., that matches) a multi-antenna configuration employing a MIMO framework used to send a corresponding PSSCH symbol.

In some examples, second UE 804 may alternate between using different antenna ports, defined by a multi-antenna configuration of a corresponding PSSCH symbol, to send (e.g., to first UE 802) respective contiguous resource block groups associated with a given PSCCH symbol. Accordingly, if a PSSCH symbol is sent using both a first antenna port “Tx1” and a second antenna port “Tx2”, then second UE 804 may send a corresponding PSCCH symbol by alternating between using the first antenna port “Tx1” and the second antenna port “Tx2” for each of multiple contiguous resource block group associated with the PSCCH symbol. In certain aspects, first UE 802 may divide channel estimation into groups of resource blocks (e.g., precoding resource block groups or physical resource block groups (PRGs)) such that first UE 802 may decode the PSCCH data without any explicit indication of an antenna port configuration used to transmit the PSCCH data.

In some examples, a PSCCH symbol includes a first resource block group and a second resource block group, where the first resource block group is sent on a first antenna and the second resource block group is sent on a second antenna. The first resource block group and the second resource block group are contiguous such that they are adjacent in frequency with no gaps between them. In some examples, the first resource block group may include example resource blocks 1-5 sent on a first antenna, and the second resource block group may include example resource blocks 6-10 sent on a second antenna, where resource blocks 6-10 are adjacent to resource blocks 1-5. The first resource block group and the second resource block group may be multiplexed in time. UEs that are multiplexed in time share the same frequency resources but are assigned different time intervals for their transmissions. In certain aspects, both first UE 802 and second UE 804 (e.g., the receiver and the transmitter) each utilize resource block groups of a preconfigured size (per resource pool) to maintain alignment between the transmitter and the receiver and ensure efficient data transmission. In some aspects, the preconfigured resource block group size may be 2 resource blocks per group, 4 resource blocks per group, or the like. The resource block group size may impact a quantity of estimation discontinuities. In some examples, as the resource block group size increases, the number of channel estimation discontinuities will decrease, thereby improving channel estimation accuracy. However, increasing resource block group size may also decrease accuracy of the AGC power relative to one or more PSSCH-only symbols due to channel effects causing fluctuations in received power for different frequencies. Accordingly, resource block group size may be managed to balance the above-described tradeoff affecting both the quantity of estimation discontinuities and the accuracy of the AGC power relative to PSSCH-only symbols. In some examples, the resource block group size may be dynamically allocated through sidelink control signaling, such as by transmitting sidelink control information between first UE 802 and second UE 804 to determine a shared resource block group size to be used. In aspects, the preconfigured resource block group size matches or is derived from a size or one or more boundaries of the PSCCH resources to ensure there are no partial resource block groups at the edge of the PSCCH that only partially overlap with the allocated resource blocks for the PSCCH.

At 808, first UE 802 obtains the PSCCH or PSSCH transmission. Because PSCCH symbols of the obtained transmission were sent using the multi-antenna configuration of a corresponding PSSCH symbol (rather than a single fixed port), the received power (such as from the perspective of a receiving antenna of first UE 802) for the PSCCH symbol will more closely match a corresponding PSSCH symbol than if the PSCCH symbol were sent using the single fixed port. Thus, the received signals based on PSCCH symbols more closely reflects the power received in both the control and data portions of the slot.

At 810, first UE 802 performs AGC in accordance with a corresponding AGC symbol. In some aspects, performing AGC at 810 is part of obtaining the PSCCH or PSSCH transmission at 808. In some examples, first UE 802 will perform AGC to set AGC parameters for reception of a given PSCCH transmission in accordance with a corresponding PSCCH AGC symbol 0. Because the PSCCH AGC symbol is transmitted with a same configuration (e.g., set of antenna ports, transmit power, etc.) as a corresponding PSSCH symbol, first UE 802 can make an efficient determination regarding what gain to set for the slot based on the similar received power. This provides the technical benefit of reducing saturation and/or quantization errors when first UE 802 performs AGC based on the corresponding AGC symbol, thereby providing the technical benefit of reducing saturation and/or quantization errors when first UE 802 performs AGC based on the corresponding AGC symbol.

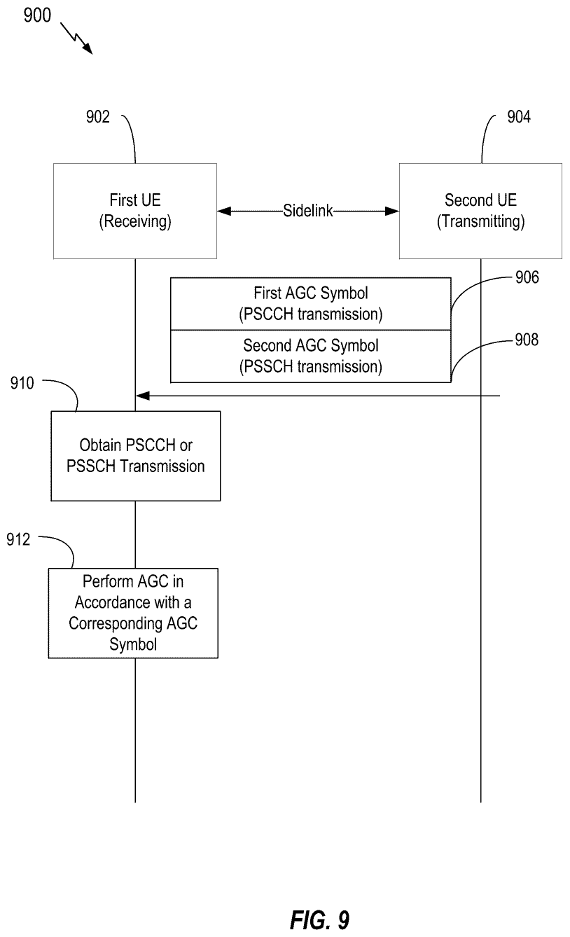

FIG. 9 depicts a process flow 900 for communications between a first UE 902 receiving a transmission, and a second UE 904 transmitting (e.g., sending) a transmission over a sidelink. In certain aspects, first UE 902 and second UE 904 may be referred to as “devices”. In process flow 900, second UE 904 sends a first AGC symbol associated with a PSCCH transmission and a second AGC symbol associated with a PSSCH transmission. An AGC symbol that is associated with a PSSCH transmission is any symbol that carries data information as part of the PSSCH transmission within a given slot. An AGC symbol that is associated with a PSCCH transmission is any symbol that carries control information as part of the PSCCH transmission within a given slot. In some aspects, the first AGC symbol may include an OFDM symbol, and the second AGC symbol may include an OFDM symbol.

The first AGC symbol and the second AGC symbol may be provided within a symbol length of the same slot. The symbol length of the sidelink may include a first portion that includes a first AGC symbol associated with a PSSCH transmission, and a second portion that includes a second AGC symbol associated with a PSCCH portion. For example, the sidelink may be configured with a subcarrier spacing that indicates a length of a slot and of symbols within the slot. The first AGC symbol and the second AGC symbol (which may be individual OFDM symbols) may be generated at a higher subcarrier spacing that is associated with a shorter slot/symbol length than the sidelink's subcarrier spacing. For example, the sidelink may be configured with a first subcarrier spacing of 30 KHz, and the first AGC symbol and the second AGC symbol may be generated with a second subcarrier spacing of 60 KHz. Thus, the first AGC symbol and the second AGC symbol both fit within the length of a single OFDM symbol at the first subcarrier spacing.

Process flow 900 enables first UE 902 to obtain at least one of the PSCCH transmission or the PSSCH transmission and perform AGC in accordance with a gain parameter associated with a corresponding first AGC symbol or second AGC symbol. This may provide the technical benefit of allowing the first UE 902 to utilize an AGC symbol that more closely reflects the power received in both the control and data portions of the slot, thereby reducing saturation and/or quantization errors Compressing the first AGC symbol associated with a PSCCH transmission and the second AGC symbol associated with a PSSCH transmission within the symbol length of a slot further provides the technical benefit of reducing overhead costs (such as bandwidth) from the perspective of second UE 904 as compared to sending two separate AGC symbols in two respective slot lengths.

In some aspects, UEs 902 and 904 may be an example of UE 104 depicted and described with respect to FIG. 1 or the UE 304 depicted and described with respect to FIG. 3. However, in other aspects, UEs 902 and 904 may be another type of wireless communications device, such as those described herein. Note that any operations or signaling illustrated with dashed lines may indicate that that operation or signaling is an optional or alternative example.

At 906, second UE 904 sends a first AGC symbol associated with a PSCCH transmission. The first AGC symbol can be used to set AGC parameters for reception of a given PSCCH transmission. At 908, second UE 904 sends a second AGC symbol associated with a PSSCH transmission. The second AGC symbol can be used to set AGC parameters for reception of a given PSSCH transmission. For example, the first AGC symbol may be transmitted with a same configuration (e.g., set of antenna ports, transmit power, etc.) as the given PSCCH transmission, and the second AGC symbol may be transmitted with a same configuration (e.g., set of antenna ports, transmit power, etc.) as the given PSSCH transmission.

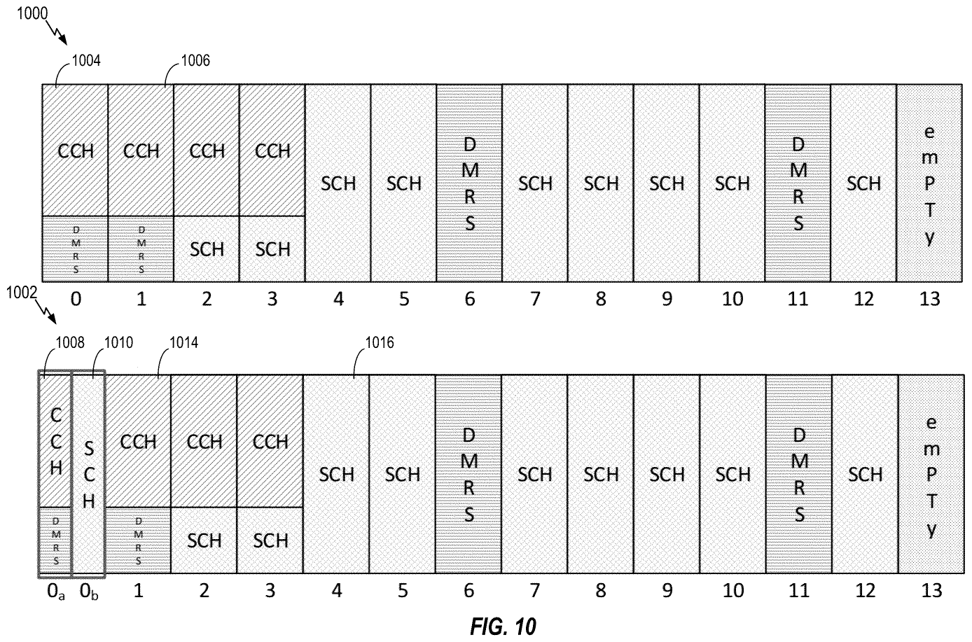

In some examples, second UE 904 sends the first AGC symbol and the second AGC symbol in a single orthogonal frequency division multiplexing symbol (for example, as shown at 1012 of slot 1002 described below with reference to FIG. 10). In other words, to avoid repurposing data symbols (and decreasing throughput), each of the first and second AGC symbols can use a doubled subcarrier spacing relative to the PSSCH transmission or PSCCH transmission, thereby halving the symbol length. In certain aspects, the first AGC symbol is a diluted duplication of a first PSCCH symbol of a corresponding slot, and the second AGC symbol is a diluted duplication of a first sequential PSSCH-only symbol. As used herein, a “diluted duplication” refers to a symbol that is a duplicate of a given PSSCH or PSCCH symbol, and utilizes only even or odd tones of the given PSSCH or PSCCH symbol, thereby utilizing only half the symbol length as compared to the PSSCH or PSCCH symbol. From the perspective of receiving first UE 902, the first AGC symbol has a same received power property as the PSCCH transmission and the second AGC symbol has a same received power property as the PSSCH transmission. As used herein, a “received power property” refers to a ratio between a received energy of a symbol and a symbol duration of the symbol. Because the PSCCH and PSSCH occupy contiguous frequency range without gaps, the first AGC symbol and the second AGC symbol preserve the total received power for the channel, despite being diluted duplications. For example, the energy and symbol duration of the first AGC symbol and the second AGC symbol may each be decreased by a factor of 2, such that the received power property remains constant. The described transmission scheme usable to send a first and second AGC symbol in a shared slot length provides the technical benefit of reducing overhead costs (such as bandwidth) from the perspective of second UE 904 as compared to sending two separate AGC symbols in two respective slot lengths to account for PSSCH and PSCCH received power.

In certain aspects, at 906 and 908, second UE 904 sends a first AGC symbol that is a duplication of a first sequential PSCCH symbol of the slot (for example, as shown at 1004 of slot 1000 described below with reference to FIG. 10), and a second AGC symbol that is a duplication of a first sequential PSSCH symbol of the slot. The first AGC symbol can be used to set AGC parameters for reception of a given PSCCH transmission. The second AGC symbol can be used to set AGC parameters for reception of a given PSSCH transmission. This enables first UE 902 to process both the first AGC symbol and the second AGC symbol to make an efficient determination regarding what gain to set for the slot.

At 910, first UE 902 obtains a PSCCH or PSSCH transmission. At 912, first UE 902 performs AGC in accordance with a corresponding first or second AGC symbol received from second UE 904 as described above. In some examples, first UE 902 may perform AGC for an obtained PSCCH transmission in accordance with a received first AGC symbol received from second UE 904 as described above at 906. In other examples, first UE 902 may perform AGC for an obtained PSSCH transmission in accordance with a received second AGC symbol received from second UE 904 as described above at 908. Accordingly, UE 902 is able to utilize a received AGC symbol that more closely reflects the power received in both the control and data portions of the slot, thereby reducing saturation and/or quantization errors.

Note that the process flows illustrated in FIGS. 8-9 are described herein to facilitate an understanding of techniques for signaling of PSCCH/PSSCH symbols for improved AGC, and aspects of the present disclosure may be performed in various manners via alternative or additional signaling and/or operations. In certain aspects, the operations and/or signaling of FIGS. 8-9 may occur in an order different from that described or depicted, and various actions, operations, and/or signaling may be added, omitted, or combined.

### Example Slots and PSCCH/PSSCH Symbols for Improved AGC

FIG. 10 depicts example slots including symbols usable by a receiving UE for performing automatic gain control. FIG. 10 includes a first example slot 1000. Slot 1000 includes a first OFDM symbol 1004 for a PSCCH symbol that is a duplicate of an OFDM symbol 1006 immediately following the first OFDM symbol 1004. This allows a receiving UE to adjust its AGC immediately preceding the OFDM symbol 1006 in the slot and prevent corruption of the first data/control carrying symbol, while also improving decoding performance based on the redundancy of the duplicated symbol. However, as discussed above, the techniques used to generate the symbols of slot 1000 do not account for potential received power differences between the first OFDM symbol 1004 and the following symbols due to different transmission schemes of the PSCCH and PSSCH channels, such as PSCCH being transmitted using only a single port as compared to PSSCH being transmitted using a multi-antenna configuration.

FIG. 10 further depicts a second example slot 1002 based on techniques for transmitting PSCCH/PSSCH symbols for improved AGC according to one or more described aspects. Slot 1002 includes a first AGC symbol 1008 and a second AGC symbol 1010 transmitted in accordance with described aspects. First AGC symbol 1008 represented as symbol “0ₐ” is a diluted duplication of a following PSCCH symbol 1014 that is positioned at symbol “1” of slot 1002. Second AGC symbol 1010, represented as symbol “0_{b}” is a diluted duplication of a following PSSCH symbol 1016 that is positioned at a symbol “4” of slot 1002. First AGC symbol 1008 and second AGC symbol 1010 share a symbol length having doubled subcarrier spacing and half the frequency resources as compared to the following OFDM symbol lengths. As described above, this provides the technical benefit of reducing overhead costs, such as bandwidth, used to transmit the AGC symbols, while still ensuring that both first AGC symbol 1008 and second AGC symbol 1010 are available for consideration by a receiving UE. The receiving UE may then perform accurate AGC based on both the first and second AGC symbols representing the received power in both the control and data portions of the slot, thereby providing the technical benefit of reducing saturation and/or quantization errors.

### Example Operations of a User Equipment

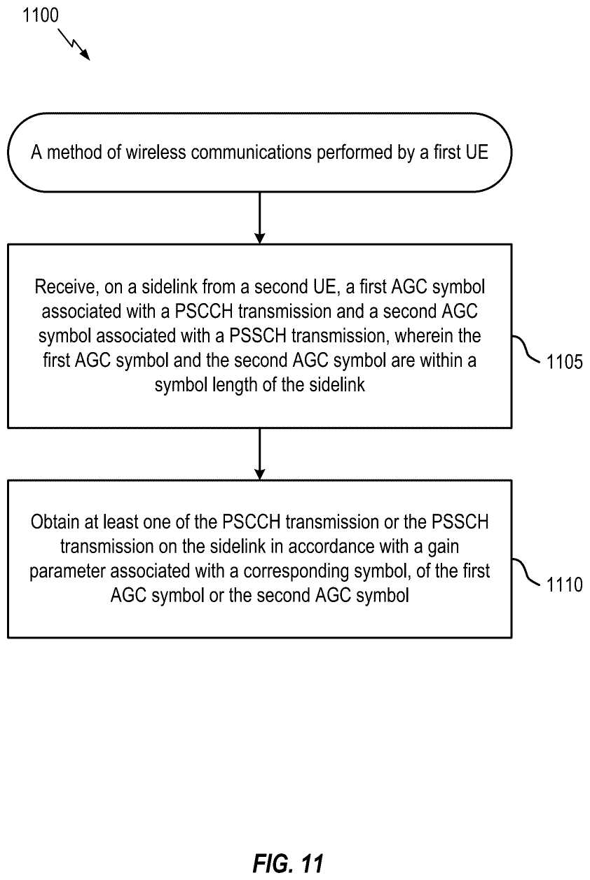

FIG. 11 shows a method 1100 for wireless communications performed by a first UE, such as UE 104 of FIG. 1 or UE 304 of FIG. 3.

Method 1100 begins at block 1105 with receiving, on a sidelink from a second UE, a first AGC symbol associated with a PSCCH transmission and a second AGC symbol associated with a PSSCH transmission, wherein the first AGC symbol and the second AGC symbol are within a symbol length of the sidelink. For example, the receiving of the first AGC symbol associated with the PSCCH transmission and the second AGC symbol associated with the PSSCH transmission may correspond to 906 and 908 of FIG. 9.

Method 1100 then proceeds to block 1110 with obtaining at least one of the PSCCH transmission or the PSSCH transmission on the sidelink in accordance with a gain parameter associated with a corresponding symbol, of the first AGC symbol or the second AGC symbol. For example, the obtaining of the at least one of the PSCCH transmission or the PSSCH transmission on the sidelink in accordance with a gain parameter associated with a corresponding symbol may correspond to 910 of FIG. 9. Method 1100 thus provides the technical benefit of allowing the receiving UE to utilize an AGC symbol that more closely reflects the power received in both the control and data portions of the slot, thereby providing the technical benefit of reducing saturation and/or quantization errors.

In some aspects, the first AGC symbol and the second AGC symbol are in a single orthogonal frequency division multiplexing symbol.

In some aspects, the first AGC symbol comprises a diluted duplication of a first sequential PSCCH symbol, and the second AGC symbol comprises a diluted duplication of a first sequential PSSCH symbol associated with the PSSCH transmission.

In some aspects, the first AGC symbol and the second AGC symbol each utilize a first subcarrier spacing that is doubled as compared to a second subcarrier spacing of the PSSCH transmission.

In some aspects, the first AGC symbol has a same first received power property as the PSCCH transmission and the second AGC symbol has a same received power property as the PSSCH transmission.

In some aspects, block 1110 includes obtaining the PSCCH transmission, wherein the gain parameter is associated with the first AGC symbol.

In some aspects, block 1110 includes obtaining the PSSCH transmission, wherein the gain parameter is associated with the second AGC symbol.

In some aspects, method 1100 further includes identifying the gain parameter by measuring a signal strength of the corresponding symbol.

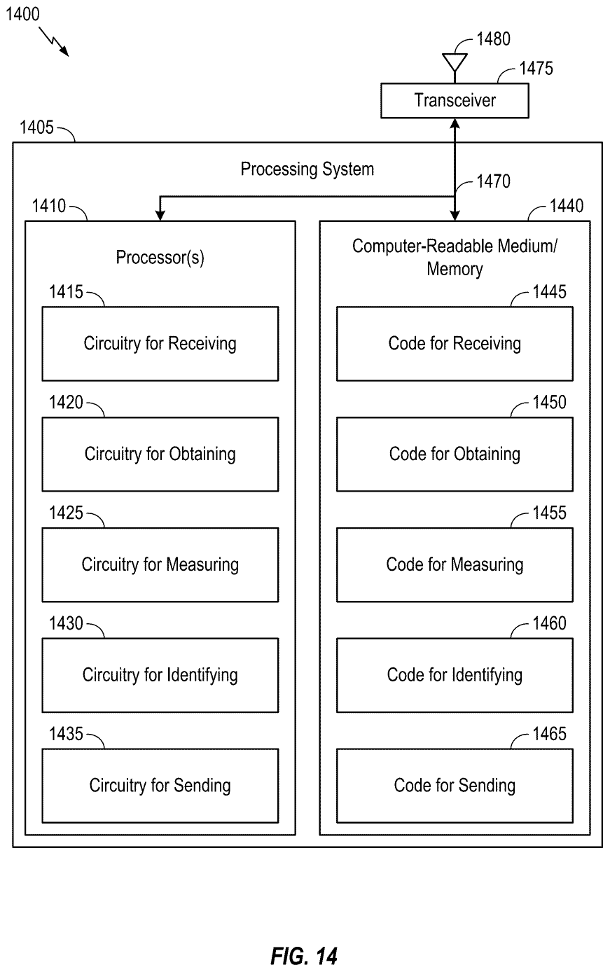

In some aspects, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative operations are possible consistent with this disclosure.

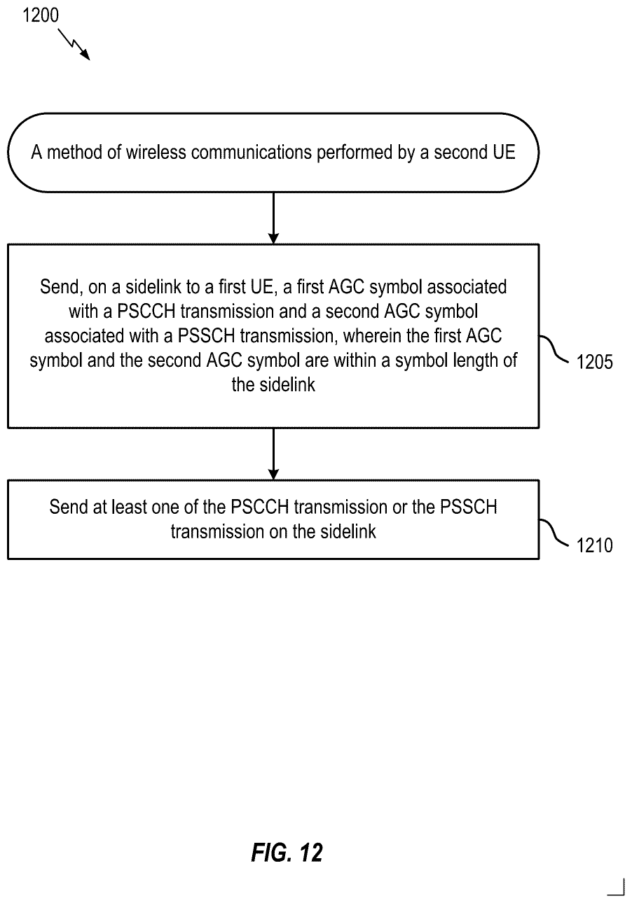

FIG. 12 shows a method 1200 for wireless communications performed by a second UE, such as UE 104 of FIG. 1 or UE 304 of FIG. 3.

Method 1200 begins at block 1205 with sending, on a sidelink to a first UE, a first AGC symbol associated with a PSCCH transmission and a second AGC symbol associated with a PSSCH transmission, wherein the first AGC symbol and the second AGC symbol are within a symbol length of the sidelink. For example, the sending of the first AGC symbol associated with the PSCCH transmission and the second AGC symbol associated with a PSSCH transmission may correspond to 906 and 908 of FIG. 9. Method 1200 provides the technical benefit of enabling a transmitting UE to provide a receiving UE with the first AGC symbol and the second AGC symbol to make an efficient determination regarding what gain to set for the slot for reception of a given PSCCH or PSSCH transmission, thereby providing the technical benefit of reducing saturation and/or quantization errors.

Method 1200 then proceeds to block 1210 with sending at least one of the PSCCH transmission or the PSSCH transmission on the sidelink. For example, the sending of the first AGC symbol associated with the PSCCH transmission and the second AGC symbol associated with a PSSCH transmission may correspond to 906 and 908 of FIG. 9.

In some aspects, the first AGC symbol and the second AGC symbol are in a single orthogonal frequency division multiplexing symbol.

In some aspects, the first AGC symbol comprises a diluted duplication of a first sequential PSCCH symbol, and the second AGC symbol comprises a diluted duplication of a first sequential PSSCH symbol associated with the PSSCH transmission.

In some aspects, the first AGC symbol and the second AGC symbol each utilize a first subcarrier spacing that is doubled as compared to a second subcarrier spacing of the PSSCH transmission.

In some aspects, the first AGC symbol has a same first received power property as the PSCCH transmission and the second AGC symbol has a same received power property as the PSSCH transmission.

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

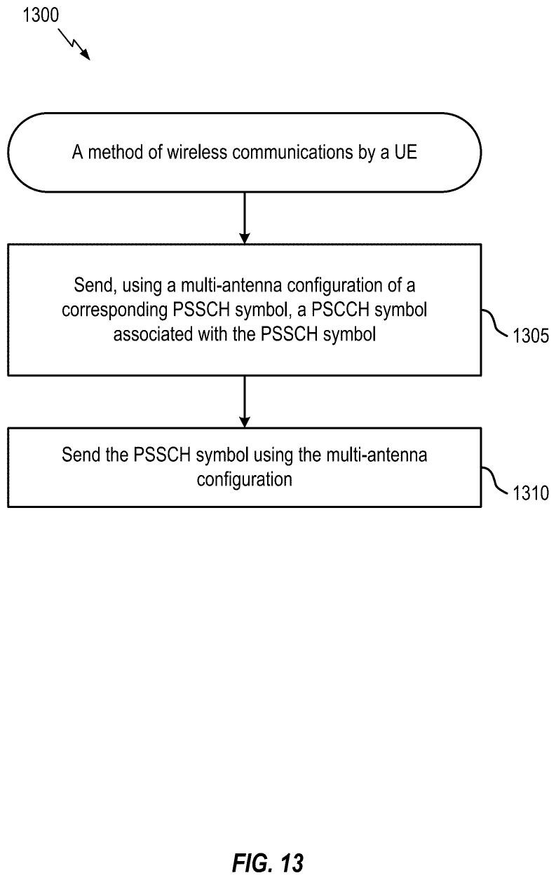

FIG. 13 shows a method 1300 for wireless communications by a UE, such as UE 104 of FIG. 1 or UE 304 of FIG. 3.

Method 1300 begins at block 1305 with sending, using a multi-antenna configuration of a corresponding PSSCH symbol, a PSCCH symbol associated with the PSSCH symbol. For example, the sending of the PSCCH symbol using the multi-antenna configuration of the corresponding PSSCH symbol may correspond to 806 of FIG. 8. Method 1300 provides the technical benefit of aligning the number of antenna ports used to transmit the PSCCH symbol with the number of antenna ports used to transmit the corresponding PSSCH symbol, thereby matching the transmission powers for the PSCCH and PSSCH transmissions. This provides the technical benefit of enabling a UE receiving the PSCCH and/or PSSCH transmission to make an efficient determination regarding what gain to set for the slot based on the similar received powers of the PSSCH and PSCCH symbols, thereby providing the technical benefit of reducing saturation and/or quantization errors.

Method 1300 then proceeds to block 1310 with sending the PSSCH symbol using the multi-antenna configuration. For example, the sending of the PSSCH symbol may correspond to 806 of FIG. 8.

In some aspects, the multi-antenna configuration indicates a first antenna and a second antenna for transmission of the PSSCH symbol, wherein the PSCCH symbol includes a first resource block group and a second resource block group, wherein the first resource block group is sent on the first antenna and the second resource block group is sent on the second antenna.

In some aspects, the first resource block group and the second resource block group are multiplexed in time.

In some aspects, the multi-antenna configuration is associated with a multiple-input multiple-output framework.

In some aspects, the multi-antenna configuration indicates a first antenna and a second antenna for transmission of the PSSCH symbol, wherein the PSCCH symbol includes a first resource block group and a second resource block group, wherein the first resource block group and the second resource block group are both sent on each of the first antenna and the second antenna.

In some aspects, the multi-antenna configuration is associated with a cyclic delay diversity framework.

In some aspects, the PSSCH symbol is part of a cyclic delay diversity communication.

In some aspects, the PSSCH symbol is part of a multiple-input multiple-output communication.

In some aspects, a resource block group size of a communication associated with the PSSCH symbol is configured in association with a resource pool on which the PSSCH symbol is sent.

In some aspects, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1475 (e.g., a transmitter and/or a receiver). The transceiver 1475 is configured to transmit and receive signals for the communications device 1400 via an antenna 1480, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1440. In various aspects, the one or more processors 1410 may be representative of the one or more processors 318 described with respect to FIG. 3. The one or more processors 1410 are coupled to a computer-readable medium/memory 1440 via a bus 1470. In some aspects, the computer-readable medium/memory 1440 may be representative of the one or more memories 320 described with respect to FIG. 3. The computer-readable medium/memory 1440 is a non-transitory computer-readable medium/memory. In certain aspects, the computer-readable medium/memory 1440 is configured to store instructions (e.g., computer-executable code), that when executed by the one or more processors 1410, cause the one or more processors 1410 to perform the method 1100 described with respect to FIG. 11, or any aspect related to it, including any operations described in relation to FIG. 11; the method 1200 described with respect to FIG. 12, or any aspect related to it, including any operations described in relation to FIG. 12; and the method 1300 described with respect to FIG. 13, or any aspect related to it, including any operations described in relation to FIG. 13. Note that reference to a processor performing a function of communications device 1400 may include one or more processors performing that function of communications device 1400, such as in a distributed fashion.

In the depicted example, computer-readable medium/memory 1440 stores code (e.g., executable instructions), including code for receiving 1445, code for obtaining 1450, code for measuring 1455, code for identifying 1460, and code for sending 1465. Processing of the code 1445-1465 may enable and cause the communications device 1400 to perform the method 1100 described with respect to FIG. 11, or any aspect related to it; the method 1200 described with respect to FIG. 12, or any aspect related to it; and the method 1300 described with respect to FIG. 13, or any aspect related to it. For instance, in some aspects, code for receiving 1445 includes code for receiving, on a sidelink from a second UE, a first AGC symbol associated with a PSCCH transmission and a second AGC symbol associated with a PSSCH transmission, wherein the first AGC symbol and the second AGC symbol are within a symbol length of the sidelink. In some aspects, code for obtaining 1450 includes code for obtaining at least one of the PSCCH transmission or the PSSCH transmission on the sidelink in accordance with a gain parameter associated with a corresponding symbol, of the first AGC symbol or the second AGC symbol. For instance, in some aspects, code for sending 1465 includes code for sending, on a sidelink to a first UE, a first AGC symbol associated with a PSCCH transmission and a second AGC symbol associated with a PSSCH transmission, wherein the first AGC symbol and the second AGC symbol are within a symbol length of the sidelink. In some aspects, code for sending 1465 includes code for sending at least one of the PSCCH transmission or the PSSCH transmission on the sidelink. For instance, in some aspects, code for sending 1465 includes code for sending, using a multi-antenna configuration of a corresponding PSSCH symbol, a PSCCH symbol associated with the PSSCH symbol. In some aspects, code for sending 1465 includes code for sending the PSSCH symbol using the multi-antenna configuration.

The one or more processors 1410 include circuitry configured to implement (e.g., execute) the code stored in the computer-readable medium/memory 1440, including circuitry for receiving 1415, circuitry for obtaining 1420, circuitry for measuring 1425, circuitry for identifying 1430, and circuitry for sending 1435. Processing with circuitry 1415-1435 may enable and cause the communications device 1400 to perform the method 1100 described with respect to FIG. 11, or any aspect related to it; the method 1200 described with respect to FIG. 12, or any aspect related to it; and the method 1300 described with respect to FIG. 13, or any aspect related to it. For instance, in some aspects, circuitry for receiving 1415 includes circuitry for receiving, on a sidelink from a second UE, a first AGC symbol associated with a PSCCH transmission and a second AGC symbol associated with a PSSCH transmission, wherein the first AGC symbol and the second AGC symbol are within a symbol length of the sidelink. In some aspects, circuitry for obtaining 1420 includes circuitry for obtaining at least one of the PSCCH transmission or the PSSCH transmission on the sidelink in accordance with a gain parameter associated with a corresponding symbol, of the first AGC symbol or the second AGC symbol. For instance, in some aspects, circuitry for sending 1435 includes circuitry for sending, on a sidelink to a first UE, a first AGC symbol associated with a PSCCH transmission and a second AGC symbol associated with a PSSCH transmission, wherein the first AGC symbol and the second AGC symbol are within a symbol length of the sidelink. In some aspects, circuitry for sending 1435 includes circuitry for sending at least one of the PSCCH transmission or the PSSCH transmission on the sidelink. For instance, in some aspects, circuitry for sending 1435 includes circuitry for sending, using a multi-antenna configuration of a corresponding PSSCH symbol, a PSCCH symbol associated with the PSSCH symbol. In some aspects, circuitry for sending 1435 includes circuitry for sending the PSSCH symbol using the multi-antenna configuration.

More generally, means for communicating, transmitting, sending or outputting for transmission may include the one or more transceivers 324, one or more antenna 322 and/or processing system 316 of the UE 304 illustrated in FIG. 3, transceiver 1475 and/or antenna 1480 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1475 and/or antenna 1480 of the communications device 1400 in FIG. 14, and/or one or more processors 1410 of the communications device 1400 in FIG. 14.

### EXAMPLE CLAUSES

Implementation examples are described in the following numbered clauses:

Clause 1: A method of wireless communications performed by a first UE, comprising: receiving, on a sidelink from a second UE, a first AGC symbol associated with a PSCCH transmission and a second AGC symbol associated with a PSSCH transmission, wherein the first AGC symbol and the second AGC symbol are within a symbol length of the sidelink; and obtaining at least one of the PSCCH transmission or the PSSCH transmission on the sidelink in accordance with a gain parameter associated with a corresponding symbol, of the first AGC symbol or the second AGC symbol.

Clause 2: The method of Clause 1, wherein the first AGC symbol and the second AGC symbol are in a single orthogonal frequency division multiplexing symbol.

Clause 3: The method of any one of Clauses 1-2, wherein the first AGC symbol comprises a diluted duplication of a first sequential PSCCH symbol, and the second AGC symbol comprises a diluted duplication of a first sequential PSSCH symbol associated with the PSSCH transmission.

Clause 4: The method of any one of Clauses 1-3, wherein the first AGC symbol and the second AGC symbol each utilize a first subcarrier spacing that is doubled as compared to a second subcarrier spacing of the PSSCH transmission.

Clause 5: The method of any one of Clauses 1-4, wherein the first AGC symbol has a same first received power property as the PSCCH transmission and the second AGC symbol has a same received power property as the PSSCH transmission.

Clause 6: The method of any one of Clauses 1-5, wherein obtaining at least one of the PSCCH transmission or the PSCCH transmission comprises obtaining the PSCCH transmission, wherein the gain parameter is associated with the first AGC symbol.

Clause 7: The method of any one of Clauses 1-6, wherein obtaining at least one of the PSCCH transmission or the PSCCH transmission comprises obtaining the PSSCH transmission, wherein the gain parameter is associated with the second AGC symbol.

Clause 8: The method of any one of Clauses 1-7, further comprising identifying the gain parameter by measuring a signal strength of the corresponding symbol.

Clause 9: A method of wireless communications performed by a second UE, comprising: sending, on a sidelink to a first UE, a first AGC symbol associated with a PSCCH transmission and a second AGC symbol associated with a PSSCH transmission, wherein the first AGC symbol and the second AGC symbol are within a symbol length of the sidelink; and sending at least one of the PSCCH transmission or the PSSCH transmission on the sidelink.

Clause 10: The method of Clause 9, wherein the first AGC symbol and the second AGC symbol are in a single orthogonal frequency division multiplexing symbol.

Clause 11: The method of any one of Clauses 9-10, wherein the first AGC symbol comprises a diluted duplication of a first sequential PSCCH symbol, and the second AGC symbol comprises a diluted duplication of a first sequential PSSCH symbol associated with the PSSCH transmission.

Clause 12: The method of any one of Clauses 9-11, wherein the first AGC symbol and the second AGC symbol each utilize a first subcarrier spacing that is doubled as compared to a second subcarrier spacing of the PSSCH transmission.

Clause 13: The method of any one of Clauses 9-12, wherein the first AGC symbol has a same first received power property as the PSCCH transmission and the second AGC symbol has a same received power property as the PSSCH transmission.

Clause 14: A method of wireless communications by a UE, comprising: sending, using a multi-antenna configuration of a corresponding PSSCH symbol, a PSCCH symbol associated with the PSSCH symbol; and sending the PSSCH symbol using the multi-antenna configuration.

Clause 15: The method of Clause 14, wherein the multi-antenna configuration indicates a first antenna and a second antenna for transmission of the PSSCH symbol, wherein the PSCCH symbol includes a first resource block group and a second resource block group, wherein the first resource block group is sent on the first antenna and the second resource block group is sent on the second antenna.

Clause 16: The method of Clause 15, wherein the first resource block group and the second resource block group are multiplexed in time.

Clause 17: The method of Clause 15, wherein the multi-antenna configuration is associated with a multiple-input multiple-output framework.

Clause 18: The method of Clause 15, wherein the PSSCH symbol is part of a multiple-input multiple-output communication.

Clause 19: The method of Clause 17, wherein the multi-antenna configuration indicates a first antenna and a second antenna for transmission of the PSSCH symbol, wherein the PSCCH symbol includes a first resource block group and a second resource block group, wherein the first resource block group and the second resource block group are both sent on each of the first antenna and the second antenna.

Clause 20: The method of Clause 19, wherein the multi-antenna configuration is associated with a cyclic delay diversity framework.

Clause 21: The method of Clause 19, wherein the PSSCH symbol is part of a cyclic delay diversity communication.

Clause 22: The method of any one of Clauses 14-21, wherein a resource block group size of a communication associated with the PSSCH symbol is configured in association with a resource pool on which the PSSCH symbol is sent.

Clause 23: One or more apparatuses, comprising: one or more memories comprising executable instructions; and one or more processors configured to execute the executable instructions and cause the one or more apparatuses to perform a method in accordance with any one of Clauses 1-22.

Clause 24: One or more apparatuses configured for wireless communications, comprising: one or more memories; and one or more processors, coupled to the one or more memories, configured to cause the one or more apparatuses to perform a method in accordance with any one of Clauses 1-22.

Clause 25: One or more apparatuses configured for wireless communications, comprising: one or more memories; and one or more processors, coupled to the one or more memories, configured to perform a method in accordance with any one of Clauses 1-22.

Clause 26: One or more apparatuses, comprising means for performing a method in accordance with any one of Clauses 1-22.

Clause 27: One or more non-transitory computer-readable media comprising executable instructions that, when executed by one or more processors of one or more apparatuses, cause the one or more apparatuses to perform a method in accordance with any one of Clauses 1-22.

Clause 28: One or more computer program products embodied on one or more computer-readable storage media comprising code for performing a method in accordance with any one of Clauses 1-22.

Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A method of wireless communications performed by a first user equipment (UE), comprising:
receiving, on a sidelink from a second UE, a first automatic gain control (AGC) symbol associated with a physical sidelink control channel (PSCCH) transmission and a second AGC symbol associated with a physical sidelink shared channel (PSSCH) transmission, wherein the first AGC symbol and the second AGC symbol are within a symbol length of the sidelink; and
obtaining at least one of the PSCCH transmission or the PSSCH transmission on the sidelink in accordance with a gain parameter associated with a corresponding symbol, of the first AGC symbol or the second AGC symbol.

2. The method of claim 1, wherein the first AGC symbol and the second AGC symbol are in a single orthogonal frequency division multiplexing symbol.

3. The method of claim 1, wherein the first AGC symbol comprises a diluted duplication of a first sequential PSCCH symbol, and the second AGC symbol comprises a diluted duplication of a first sequential PSSCH symbol associated with the PSSCH transmission.

4. The method of claim 1, wherein the first AGC symbol and the second AGC symbol each utilize a first subcarrier spacing that is doubled as compared to a second subcarrier spacing of the PSSCH transmission.

5. The method of claim 1, wherein the first AGC symbol has a same first received power property as the PSCCH transmission and the second AGC symbol has a same received power property as the PSSCH transmission.

6. The method of claim 1, wherein obtaining at least one of the PSCCH transmission or the PSCCH transmission comprises obtaining the PSCCH transmission, wherein the gain parameter is associated with the first AGC symbol.

7. The method of claim 1, wherein obtaining at least one of the PSCCH transmission or the PSCCH transmission comprises obtaining the PSSCH transmission, wherein the gain parameter is associated with the second AGC symbol.

8. The method of claim 1, further comprising identifying the gain parameter by measuring a signal strength of the corresponding symbol.

9. A method of wireless communications performed by a second user equipment (UE), comprising:
sending, on a sidelink to a first UE, a first automatic gain control (AGC) symbol associated with a physical sidelink control channel (PSCCH) transmission and a second AGC symbol associated with a physical sidelink shared channel (PSSCH) transmission, wherein the first AGC symbol and the second AGC symbol are within a symbol length of the sidelink; and
sending at least one of the PSCCH transmission or the PSSCH transmission on the sidelink.

10. The method of claim 9, wherein the first AGC symbol and the second AGC symbol are in a single orthogonal frequency division multiplexing symbol.

11. The method of claim 9, wherein the first AGC symbol comprises a diluted duplication of a first sequential PSCCH symbol, and the second AGC symbol comprises a diluted duplication of a first sequential PSSCH symbol associated with the PSSCH transmission.

12. The method of claim 7, wherein the first AGC symbol and the second AGC symbol each utilize a first subcarrier spacing that is doubled as compared to a second subcarrier spacing of the PSSCH transmission.

13. The method of claim 7, wherein the first AGC symbol has a same first received power property as the PSCCH transmission and the second AGC symbol has a same received power property as the PSSCH transmission.

14. A method of wireless communications by a user equipment (UE), comprising:
sending, using a multi-antenna configuration of a corresponding physical sidelink shared channel (PSSCH) symbol, a physical sidelink control channel (PSCCH) symbol associated with the PSSCH symbol; and
sending the PSSCH symbol using the multi-antenna configuration.

15. The method of claim 14, wherein the multi-antenna configuration indicates a first antenna and a second antenna for transmission of the PSSCH symbol, wherein the PSCCH symbol includes a first resource block group and a second resource block group, wherein the first resource block group is sent on the first antenna and the second resource block group is sent on the second antenna.

16. The method of claim 15, wherein the first resource block group and the second resource block group are multiplexed in time.

17. The method of claim 15, wherein the multi-antenna configuration is associated with a multiple-input multiple-output framework.

18. The method of claim 15, wherein the PSSCH symbol is part of a multiple-input multiple-output communication.

19. The method of claim 17, wherein the multi-antenna configuration indicates a first antenna and a second antenna for transmission of the PSSCH symbol, wherein the PSCCH symbol includes a first resource block group and a second resource block group, wherein the first resource block group and the second resource block group are both sent on each of the first antenna and the second antenna.

20. The method of claim 19, wherein the multi-antenna configuration is associated with a cyclic delay diversity framework.
